(19) United States
(12) Patent Application Publication
(10) Pub. No.: US 2018/0357741 A1
(43) Pub. Date: Dec. 13, 2018

(54) METHODS AND APPARATUSES FOR EMBEDDING AND DECODING DATA IN A THREE-DIMENSIONAL MODEL

(71) Applicant: THOMSON Licensing, Issy-les-Moulineaux (FR)

(72) Inventors: Marc JOYE, Palo Alto, CA (US); Jean-Marc BOUCQUEAU, Mouaze (FR); Marc LE LABOURIER, Rennes (FR); Marc ELUARD, Acigné (FR)

(21) Appl. No.: 15/779,076

(22) PCT Filed: Nov. 24, 2015
(86) PCT No.: PCT/US2015/062337

§ 371 Date: May 24, 2018

(51) Int. Cl. G06T 1/00; G06T 19/00

(52) U.S. Cl. CPC G06T 1/0021; G06T 19/00

(57) ABSTRACT

The present disclosure is directed to a method (100, 500) and apparatus (404A, 1000) for embedding data in a 3D model. The present disclosure provides for receiving a first 3D model comprising a plurality of polygons, selecting at least one polygon of the plurality of polygons, inserting at least one new point associated to data inside the selected at least one polygon and providing the second 3D model. The present disclosure is also directed to a method (700) and apparatus (404B, 1000) for decoding data embedded in a 3D model by receiving a 3D model including a plurality of polygons, detecting at least one added point inserted in a polygon of the plurality of polygons, decoding data associated to the detected at least one added point based on the location of the detected at least one added point inserted in the polygon, and providing the decoded data.

### TECHNICAL FIELD

The present disclosure generally relates to the field of computer graphics, and more particularly, to embedding data and decoding data embedded in a three-dimensional model.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Three-dimensional (3D) models are used in many fields, such as, but not limited to, medical industries, movies, video games, construction and so on. In recent years, 3D graphic models have become more accessible to general end users due to the usage of advanced scanning devices and the virtual-reality modeling language (VRML) for graphic description. Moreover, due to the explosive growth of the Internet and the development of digital content designing and processing techniques, many valuable materials can be represented in digital 3D model forms for exhibition and access via the Internet.

Many 3D model formats exist today for digitally representing and storing 3D models (e.g., in a file). The geometry (or shape) of a model is often stored as a set of 3D points (or vertices). The surface of the model is then stored as a series of polygons (or faces) that are constructed by indexing these vertices. The number of vertices the face or polygon may index can vary, though triangular faces with three vertices are common. A polygon is a closed plane figure including at least three vertices. Some formats allow for edges (or lines) containing two vertices. For example, two widely used 3D model formats are the Object File Format (“OFF”) and the OBJ (or .OBJ) format.

The OFF file format is a 3D format originally developed by Digital Equipment Corporation. The OFF format defines 3D objects as a list of planar polygons and the properties of the planar polygons. More specifically, an OFF file begins the 3D model representation with a line containing the number of vertices, faces, and edges of the 3D model. Next, all the vertices are listed with (x, y, z)-coordinates, one per line. Finally, the faces are specified as planar polygons, one per line, and listed as vectors containing the number of points followed by the sequence number of the composing points (indexed from zero); again one per line. It may also contain comment lines starting with the symbol “#”.

An example of a representation of a cube is shown below, using the OFF format:

OFF
# cube.off
# A cube
8 6 12
1.0 0.0 1.0
0.0 1.0 1.0
−1.0 0.0 1.0
0.0 −1.0 1.0
1.0 0.0 −1.0
0.0 1.0 −1.0
−1.0 0.0 −1.0
0.0 −1.0 −1.0
4 0 1 2 3
4 7 4 0 3
4 4 5 1 0
4 5 6 2 1
4 3 2 6 7
4 6 5 4 7

The OBJ File Format is a geometry definition file format first developed by Wavefront Technologies for its Advanced Visualizer animation package. The file format is open and has been adopted by other 3D graphics application vendors. The OBJ file format is a simple data-format that represents 3D geometry alone—namely, the position of each vertex, the UV position of each texture coordinate vertex, vertex normals, and the faces that make each polygon defined as a list of vertices, and texture vertices. Vertices are stored in a counter-clockwise order by default, making explicit declaration of face normals unnecessary. OBJ coordinates have no units, but OBJ files can contain scale information in a human readable comment line.

It is to be appreciated that some 3D formats include an additional field for adding extra information or data to the 3D model. The extra data added to the additional field can serve many useful functions. For example, this additional field can be used to add metadata to a 3D model like, for example, information about the creator of the model, the version number, a description, etc. This additional field can also be used to convey some private information. For example, the extra information may be a ciphertext which can be decrypted using a secret key. A related application resides in the polymorphic protection of 3D models. In the case of polymorphic protection of 3D models, a 3D object is given by the proxy and the “extra information” (which can also be a 3D object) is the asset. Yet another application of adding extra information is for authentication purposes. For authentication, the additional field is used to add a digital signature (or a message authentication code) of the 3D model, which can be verified to check the authenticity of a 3D model. It is to be appreciated that the above described uses for extra data stored in a 3D model are merely exemplary.

While, as described above, an additional field to add extra information is very useful in 3D applications, not all 3D formats support additional fields. Furthermore, rendering engines may crash in the presence of extra information, or if the rendering engine does not strictly respect a given format. Even when such an extra field is supported by a rendering engine, the format and/or length of the extra field can be restricted. There is therefore a need for a method for adding extra information in a given 3D model, regardless of the input 3D format.

In addition, in today's digital world of Big Data, duplication, distribution, and modification of content are much easier than in past decades. However, this also means that unauthorized duplication, distribution, and modification of valuable content are easier. One way of addressing this problem is to add watermarks to the objects in which contents are stored. Watermarks may be defined as structures containing information that are embedded in a data object (e.g., an image) for varied purposes, in such a way that, ideally, they do not substantially interfere with its intended use (e.g., viewing). Watermarks can be used, for example, to deter theft, to discourage unauthorized copying (e.g., piracy), for authentication purposes, to hide private or secret information, to notify users of how to contact a copyright owner for payment of licensing fees, or to take inventory. The technology associated with watermarks in this sense is also called steganography, data hiding, (digital) watermarking, data embedding, or fingerprinting. The technology has been applied to still images, movie images, audio data, and texts in the past, and is now also being applied to 3D models.

Therefore, it is of interest to provide efficient techniques for embedding data in a 3D model for multiple purposes generally associated with watermarking, including but not limited to copy protection, authentication and data hiding, as well as for simplifying the representation format of 3D models. The present disclosure is directed towards such a technique.

### SUMMARY

According to one aspect of the present disclosure, a method of embedding data in a 3D model is provided, the method including receiving a first 3D model including a plurality of polygons, selecting at least one polygon of the plurality of polygons, inserting at least one new point associated to data inside the selected at least one polygon to obtain a second 3D model, and providing said second 3D model.

According to another aspect of the present disclosure, an apparatus for embedding data in a 3D model is provided, the apparatus including a processor in communication with at least one input/output interface, and at least one memory in communication with the processor, the processor being configured to receive a first 3D model including a plurality of polygons, select at least one polygon of the plurality of polygons, insert at least one new point associated to data inside the selected at least one polygon to obtain a second 3D model, and provide said second 3D model.

According to another aspect of the present disclosure, a method of decoding data embedded in a 3D model is provided, the method including receiving a 3D model including a plurality of polygons, detecting at least one added point inserted in a polygon of the plurality of polygons, decoding data associated to the detected at least one added point based on the location of the detected at least one added point inserted in the polygon, and providing said decoded data.

According to another aspect of the present disclosure, an apparatus for decoding data embedded in a 3D model is provided, the apparatus including a processor in communication with at least one input/output interface, and at least one memory in communication with the processor, the processor being configured to receive a 3D model including a plurality of polygons, detect at least one added point inserted in a polygon of the plurality of polygons, decode data associated to the detected at least one added point based on the location of the detected at least one added point inserted in the polygon, and provide said decoded data.

### BRIEF DESCRIPTION OF THE DRAWINGS

These and other aspects, features and advantages of the present disclosure will be described or become apparent from the following detailed description of the preferred embodiments, which is to be read in connection with the accompanying drawings.

FIG. 1 is a flowchart of an exemplary method for embedding data in 3D models in accordance with an embodiment of the present disclosure.

FIG. 2A is an exemplary illustration of a 3D model without extra data embedded in accordance with the present disclosure.

FIG. 2B is an exemplary 3D model after extra data has been embedded in accordance with the present disclosure.

FIG. 3 illustrates an exemplary triangle in accordance with an embodiment of the present disclosure.

FIG. 4A is an exemplary system for embedding in a 3D model in accordance with the present disclosure.

FIG. 4B is an exemplary system for decoding data in a 3D model in accordance with the present disclosure.

FIG. 5 is a flowchart of an exemplary method for embedding data in 3D models in accordance with the present disclosure.

FIG. 6 is an exemplary illustration of a 3D model in the OFF format without extra data embedded and a 3D model in the OFF format after the extra data has been embedded in accordance with the present disclosure.

FIG. 7 is a flowchart of an exemplary method for decoding data in 3D models in accordance with an embodiment of the present disclosure.

FIG. 8A illustrates another exemplary 3D model in accordance with an embodiment of the present disclosure.

FIG. 8B illustrates the 3D model of FIG. 8A including embedded data in accordance with an embodiment of the present disclosure.

FIG. 8C illustrates the 3D model of FIG. 8A including embedded data in accordance with another embodiment of the present disclosure.

FIG. 9 illustrates a block diagram of a computing environment within which the present disclosure may be implemented and executed.

It should be understood that the drawings are for purposes of illustrating the concepts of the present disclosure and are not necessarily the only possible configuration for illustrating the present disclosure.

### DESCRIPTION OF THE EMBODIMENTS

It should also be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with, through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure provides for a method and apparatus for embedding data within a 3D model by inserting one or several points inside one or more polygons of a 3D model. Data embedding according to the present disclosure, is a form of watermarking, where the one or several points represent at least one watermark. In one embodiment, the embedded data (also called payload data) may be used for authentication purposes. In another embodiment, the embedded data may be used to insert encrypted information within the 3D model. In yet another embodiment, the embedded data may be used for copy protection.

In a further embodiment, the embedded data may represent extra information embedded to simplify or be consistent with a 3D model representation format. As described above, there are many different formats for representing 3D models. One property that many of these formats have in common is including sets of points forming polygons (for example, as described above in reference to the OFF format) that map the surface of a 3D object represented by the model. The present disclosure utilizes this common property to include extra data in the 3D model by adding extra or new points used to encode the extra data, and, if needed, to make the appropriate changes so that the resulting 3D model is compliant with the initial format (for example, by using these extra points in some defining polygons). The resulting 3D model is format compliant and can therefore be viewed using the same rendering engine as that of the original 3D model. Therefore, using the method and apparatus that will be described below in the present disclosure, extra data can be added to the representation of a 3D model even if the defining 3D format does not support the addition of extra data.

The present disclosure also provides for a method and apparatus for decoding data embedded within a 3D model by identifying one or several points inside one or several polygons of the 3D model and decoding or retrieving the embedded or payload data associated to the identified one or several points.

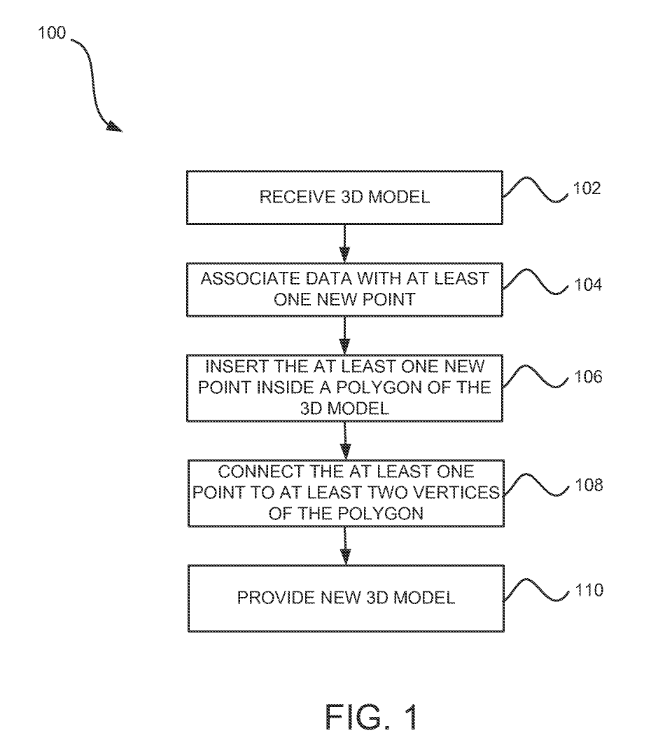

Turning to FIG. 1, a process 100 for embedding data into a 3D model is shown in accordance with the present disclosure. Initially, the process includes, in step 102, receiving a 3D model. Then, in step 104, the process includes associating at least one new point to the data which is to be added to the 3D model. After the data has been associated to the at least one new point, the process includes inserting the at least one new point inside a polygon (or face) of the received 3D model, in step 106. Then, in one embodiment of the present disclosure, the process includes connecting the at least one point that has been added to the polygon of the received 3D model to at least two vertices of the polygon, in step 108. Then, the process includes providing the new 3D model, in step 110. It is to be understood that the step of providing 110 in the present disclosure includes outputting or storing the 3D model in a visual form (e.g., drawing, assembly, print in a 2D or 3D printer, output to a Computer Aided Design—CAD display) or in a non-visual form (e.g., OFF or OBJ file).

In another embodiment of the present disclosure, step 108 may be skipped and the new 3D model is provided, in step 110, without connecting the at least one point to any vertices of the polygon. In yet another embodiment of the present disclosure, additional data may be received and at least one new point may be inserted in more than one polygon, such that steps 104 and 106, and possibly step 108, are performed for each polygon.

According to the present disclosure, each of the at least one point is determined based on at least one vertex of the polygon where the point is inserted. For example, a point may be determined as being a certain distance from a vertex in just one of the plane dimensions of the polygon (or axes, e.g., horizontal or vertical) or in two plane dimensions of the polygon. In another example, a point may be determined as being a first distance from a vertex in one plane dimension and a second distance from the vertex in a second plane dimension of the polygon. The function that identifies the distance(s) as a function of the data may be a linear or non-linear function, or it may be a table of values of data versus distance(s). It is to be appreciated that process 100 will be described in greater detail below.

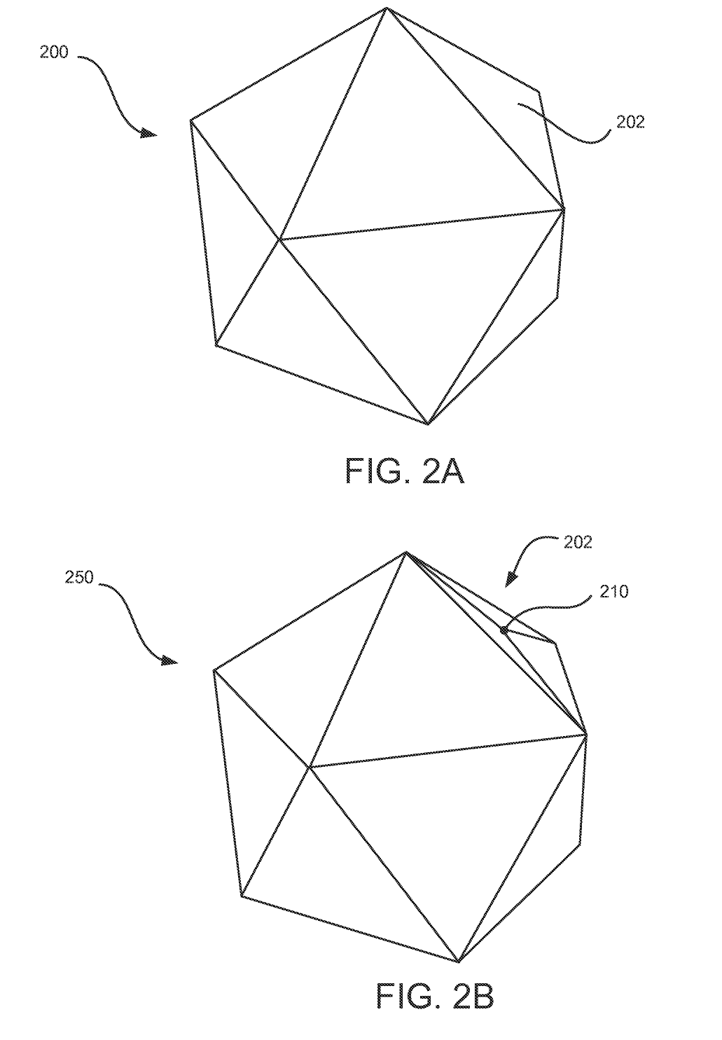

Turning to FIG. 2A, the 3D exemplary model 200 is shown in accordance with the present disclosure. Model 200 is an icosahedron (i.e., a polyhedron with 20 faces). As stated above, in many 3D formats, triangles are used to map the surface of a 3D object. As such, the surface of model 200 is represented by a plurality of triangles as seen in FIG. 2A. Using process 100, one of the plurality of triangles, for example, triangle 202, is chosen so that a new point associated with data can be added to triangle 202. Turning to FIG. 2B, model 250 is shown, where model 250 is model 200 after a new point 210 has been inserted into triangle 202 (step 106) and the point 210 has been connected to the vertices of triangle 202 (step 108). It is to be appreciated that point 210 has been associated to data that may later be decoded and retrieved, as will be described in greater detail below.

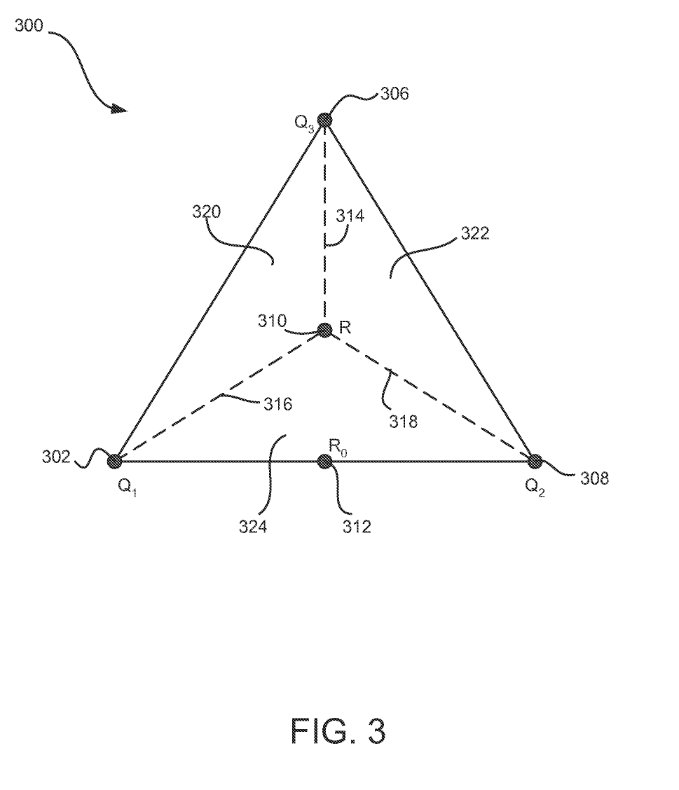

Turning to FIG. 3, an exemplary triangle 300 similar to triangle 202 (as shown in FIG. 2B) is shown in accordance with the present disclosure. Triangle 300 is formed by points or vertices 302, 306, and 308. Disposed on the line formed by point 302 and 308 is point 312. Inside triangle 300, there is point 310, where point 310 is the extra point to be added to triangle 300, as will be described in greater detail below. Point 310 in triangle 300 is similar to point 210 in triangle 202. As a result, the two respective triangles and two respective points may be referred to jointly or interchangeably in the present disclosure.

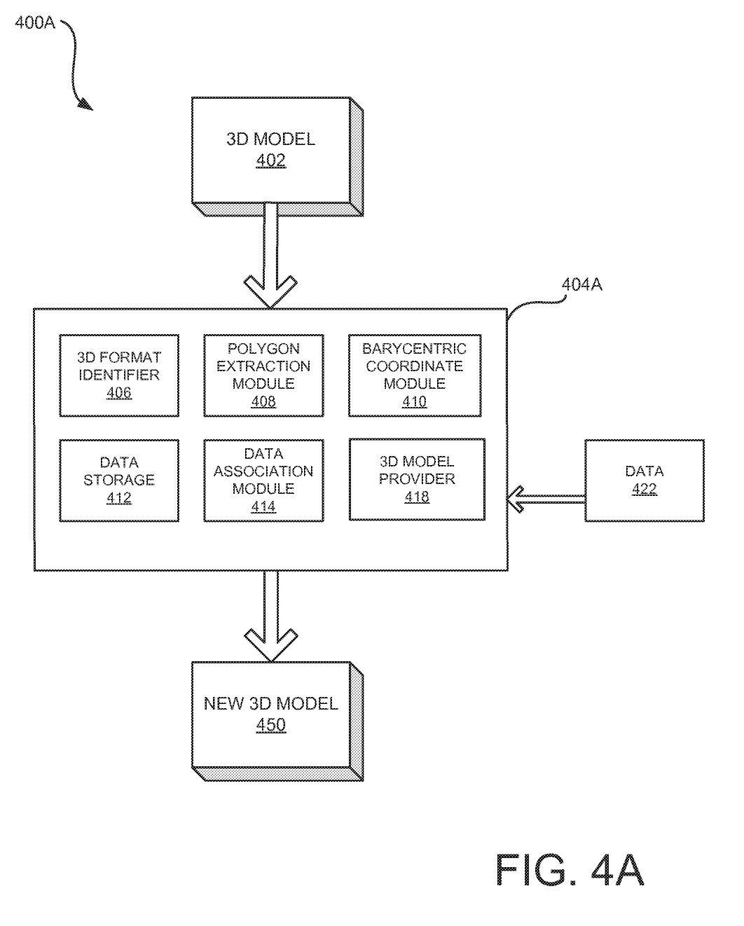

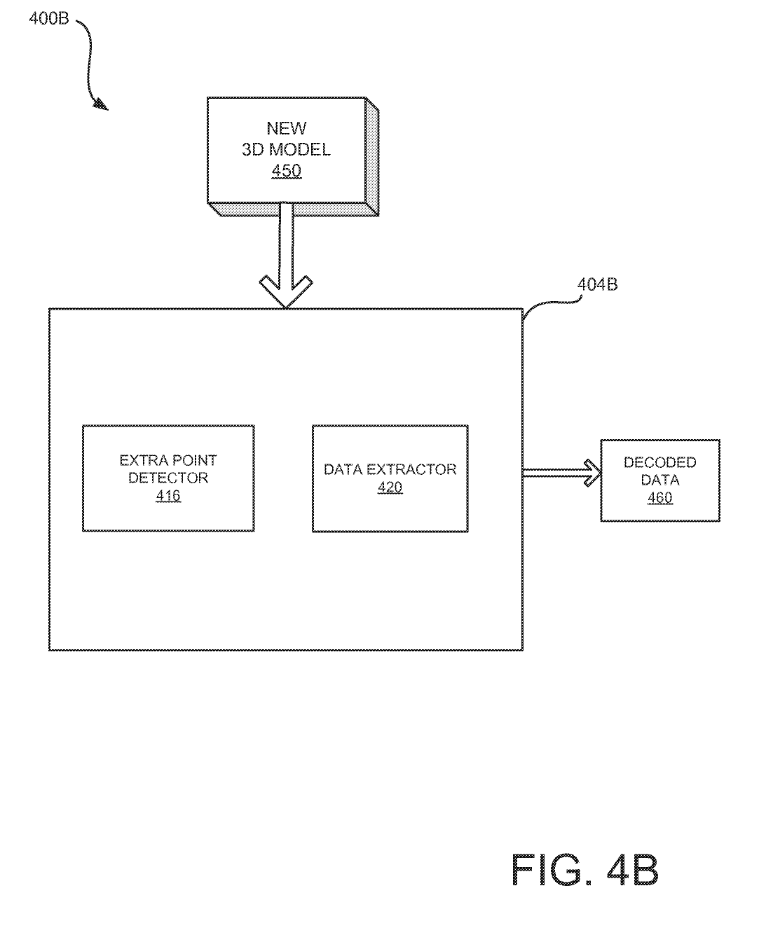

Turning to FIG. 4A, an exemplary system 400A is shown in accordance with the present disclosure. System 400A includes 3D model engine 404A, where 3D model engine 404A is configured to receive a 3D model 402 (for example, 3D model 200) in any given 3D format (for example, the OFF format) and to embed data in the 3D model (as described above in relation to process 100 and as will be described below in relation to process 500) to provide a 3D model 450 including the embedded data (for example, 3D model 250). As seen in FIG. 4A, 3D engine 404A includes 3D format identifier 406, polygon extraction module 408, barycentric coordinate module 410, data storage 412, data association module 414, and 3D model provider 418. As previously described, according to the present disclosure, providing includes outputting or storing the 3D model in a visual form (e.g., drawing, assembly, print in a 2D or 3D printer, output to a Computer Aided Design—CAD display) or in a non-visual form (e.g., OFF or OBJ file).

Turning to FIG. 4B, an exemplary apparatus 400B is shown in accordance with the present disclosure. The 3D model engine 404B is configured to receive a 3D model 450 that includes embedded data, decode the embedded data stored in 3D model 450, and provide decoded data 460.

It is to be appreciated that the engines 404A and 404B of the present disclosure may be implemented in hardware, software, firmware, or any combinations thereof. In some embodiments, the engines 404A and 404B may be implemented in software or firmware that is stored on a memory device (e.g., random access memory, read-only memory, etc.) and that is executable by a suitable instruction execution system (e.g., a processing device or processor configured to perform the steps of the software process or routine). In some embodiments, the various modules (e.g., module 406, 408, 410, 412, 414, 416, 418 and 420) may be implemented in hardware using, for example, discrete logic circuitry, an application specific integrated circuit (ASIC), a programmable gate array (PGA), a field programmable gate array (FPGA), or any combinations thereof.

As stated above, there are many 3D formats that exist to create a model of a 3D object. In one embodiment of the present disclosure, as illustrated in FIG. 4A, Engine 404A is configured such that engine 404A can detect the 3D format of a received 3D model 402. Specifically, when a 3D model 402 is received by engine 404A, 3D format identifier 406 is configured to determine the 3D format used to represent the received 3D model 402. For example, in one embodiment, the received 3D model 402 is the same as 3D model 200, and the format of 3D model 200 is in the OFF format. When engine 404A receives 3D model 200, 3D format identifier 406 will detect that 3D model 200 is in the OFF format. The 3D model may also be a 3D object assembly (e.g., a car, a toy car, etc.) or 2D drawing or print of the 3D model. In another embodiment of the present disclosure, 3D model identifier 406 may be bypassed or disabled, if the 3D model format is already known.

Additionally, engine 404A is configured such that when a 3D model 402 is received and the format of the 3D model has been identified by 3D format identifier 406 (or is already known in advance), polygon extraction module 408 can determine the polygons that map the surface of a 3D model, such as 3D model 402 or 200. Furthermore, polygon extraction module 408 can be configured to extract one or more polygons of a 3D model and identify the locations (i.e., x, y, z coordinates) of the vertices of the extracted polygons. For example, as stated above, engine 404A may receive a 3D model, such as 3D model 200 and determine (via 3D format identifier 406) that 3D model 200 is in the OFF format. After determining that 3D model 200 is in the OFF format, polygon extraction module 408 can identify one or more polygons of 3D model 200. For example, polygon extraction module 408 can identify triangle 202 of 3D model 200 (similar to triangle 300). Furthermore, polygon extraction module 408 can determine the coordinates of the vertices of triangle 202 (similar to points 302, 306, and 308 in triangle 300). Barycentric coordinate module 410 is configured to calculate barycentric coordinates associated with data, as will be described in greater detail below.

Data storage 412 is configured to store the data that is desired to be associated with a received 3D model 402, such as 3D model 200. Furthermore, data association module 414 is configured to associate the data stored in data storage 412 to at least one point to be added inside a polygon of the received 3D model 402. For example, engine 404A may receive a 3D model, such as 3D model 200, and data association module 414 will associate that data in data storage 412 to one or more new points, such as point 210, to be added inside a polygon of 3D model 200, such as triangle 202. Once data association module 414 has associated the data stored in data storage 412 to at least one new point in a polygon of the received 3D model 402 (e.g., triangles 202, similar triangle 300), 3D model provider 418, is configured to add the extra point (e.g., point 210, 310) to the received model 402. Furthermore, 3D model provider 418, in one embodiment of the present disclosure, may additionally be configured to connect the extra point (e.g., point 210, 310) to at least two of the vertices of the chosen polygon (e.g., point 310 is connected to vertices 302, 306, and 308). Finally, 3D model provider 418 is configured to provide new 3D model 450, where 3D model 450 is 3D model 400 with the data from data storage 412 associated to the at least one new point added to 3D model 400. For example, when engine 404A receives 3D model 200, 3D model provider 418 will provide 3D model 250 with added point 210 included in 3D model 250.

It is to be appreciated that barycentric coordinate module 410, data 422 and the operation of data association module 414 of engine 404A will be described in greater detail below. Furthermore, it is to be appreciated that extra point detector 416 and data extractor 420 of engine 404B will be described in greater detail below.

It is to be appreciated that, without loss of generality, any information or data can be seen as a binary string. Furthermore, it is to be appreciated that any polygon in a 3D model (such as triangle 202 of 3D model 200 shown in FIGS. 2A-B) can be seen as a set of one or several triangles. Therefore, letting Ω be the binary string representing the extra information or data that one wishes to add to a given 3D object, Ω is viewed as the concatenation of binary substrings σⱼ, namely Ω=σ₁∥σ₂∥ . . . . Each substring σⱼ is to be viewed as the encoding of a triple of reals (xⱼ, yⱼ, zⱼ) representing the coordinates of a point. In order not to have the extra point (xᵢ, yⱼ, zⱼ) (corresponding to σⱼ) distort the initial 3D object significantly, in one embodiment, this extra point (e.g., point 210 or, similarly, 310 in FIG. 3) is chosen as a point inside a triangle (for example triangles 202 or, similarly, 300) defining the 3D object. Specifically, in one embodiment, the extra point is chosen such that the extra point is located near the center of the triangle, as will be described below. It is to be appreciated that in other embodiments, the extra point is chosen inside polygons with more sides than a triangle, as will be described below. In one embodiment, the extra point is located near one of the sides of the polygon. Also it is to be appreciated that the data 422 or information Ω one wishes to embed in a 3D model, such as 3D model 200, may be stored in data storage 412 of engine 404A.

To insert an extra point, such as point 210, into a 3D model, such as model 200, the concept of barycentric coordinates is introduced by referring to triangle 300 and point 310. Assume three points are given in the 3-dimensional Euclidean space: Q₁=(x₁, y₁, z₁), Q₂=(x₂, y₂, z₂), and Q₃=(x₃, y₃, z₃)₅ where Q₁ is represented in FIG. 3 as point 302, Q₂ is represented as point 308, and Q₃ is represented by point 306. Q₁, Q₂ and Q₃ define a plane II. If a point R (where point R is represented by new point 310 in FIG. 3) in II can be written as:

R=λ₁Q₁+λ₂Q₂+λ₃Q₃ with λ₁+λ₂+λ₃=1

then (λ₁:λ₂:λ₃)_{B} are called the normalized barycentric coordinates of R. Observe that Q₁=(1:0:0)_{B}, Q₂=(0:1:0)_{B}, and Q₃=(0:0:1)_{B}. It is easily seen that any point R=(λ₁:λ₂:λ₃)_{B} with 0≤λᵢ≤1 (for 1≤i≤3) lies inside triangle 310 formed by Q₁, Q₂ and Q₃ (i.e., points 302, 306, and 308). The barycenter of triangle 310 is given by the point with coordinates (⅓:⅓:⅓)_{B}.

It is worth noting that, since λ₁+λ₂+λ₃=1, point R=(λ₁:λ₂:λ₃)_{B} can equivalently be expressed as

$$R = {λ}_{1} {Q}_{1} + {λ}_{2} {Q}_{2} + {λ}_{3} {Q}_{3} = ( 1 - {λ}_{3} ) \frac{{λ}_{1} {Q}_{1} + {λ}_{2} {Q}_{2}}{{λ}_{1} + {λ}_{2}} + {λ}_{3} {Q}_{3} = ( 1 - {λ}_{3} ) {R}_{0} + {λ}_{3} {Q}_{3} where$$

$${R}_{0} = \frac{{λ}_{1}}{{λ}_{1} + {λ}_{2}} {Q}_{1} + \frac{{λ}_{2}}{{λ}_{1} + {λ}_{2}} {Q}_{2} = ( 1 - {λ}_{0} ) {Q}_{1} + {λ}_{0} {Q}_{2} = {( 1 - {λ}_{0} \text{:} {λ}_{0} \text{:} 0 )}_{B} with$$

$${λ}_{0} = \frac{{λ}_{2}}{{λ}_{1} + {λ}_{2}}$$

is a point on the line through Q₁ and Q₂. One may observe that, when λ₁=λ₂ (and thereby λ₀=½), point R₀ (represented as point 312 in FIG. 3) is the middle point of the segment Q₁Q₂ (i.e., the line formed by points 302 and 308).

It is to be appreciated that although, the extra point 210 (or 310) may be added anywhere within a polygon (e.g., triangle 202 or 300 in the currently described embodiment), it may be desirable to include the new point in a “central” or “balanced” location (i.e., close to the center of triangle 202, or similar triangle 300) as it is more pleasing to the eye of the user and will not distort the original 3D model significantly. For example, if λ₁ and λ₂ (and thus λ₃) are set close to ⅓, the new triangles created (i.e., triangles 320, 322, and 324) after the extra point (i.e., point 310) has been added will be more balanced. The algorithm requires parameters T, T′, t, t′ with 1≤t<T and 0≤t′<T′. Let P denote the representation of the initial 3D object, such as model 200 shown in FIG. 2A, and let P_{A} denote the representation of the 3D object with the new data embedded in the new point, such as point 210 in model 250 shown in FIG. 2B (or, similarly, 310 in triangle 300 of FIG. 3). Let also bₗ₋₁ . . . b₄b₃b₂b₁b₀ denote the binary representation of Ω, where bᵢϵ{0,1} for 0≤i≤l−1. Then, in one embodiment, the following algorithm may be used to add an extra point (e.g., point 210) to a 3D model (e.g., 3D model 200):
1. Initialize k←0 and P_{A}←P;
2. Define

$${λ}_{3} = \frac{1}{3} + {\sum }_{i = 0}^{t - 1} {b}_{k + i} {2}^{i - T}$$

and, letting k′=k+t,

$${λ}_{0} = \frac{1}{2} + {\sum }_{i = 0}^{{t}^{′} - 1} {b}_{{k}^{′} + i} {2}^{i - {T}^{′}} .$$

[Leading 0's can be appended to Ω if there are less than t+t′ bits remaining in Ω.]
3. Select a triangle Q₁Q₂Q₃ in 3D-model P_{A} and define:

R=(1−λ₃)R₀+λ₃Q₃
where R₀=(1−λ₀)Q₁+λ₀Q₂.
4. Add point R to P_{A}.
5. Replace triangle Q₁Q₂Q₃ with triangles Q₁Q₂R, Q₂Q₃R and Q₃Q₁R in P_{A}.
6. Set k←k+t+t′. If k<l then go to Step 1.
7. Return P_{A}.

Although in the algorithm above it is shown that triangle Q₁Q₂Q₃ is replaced with triangles Q₁Q₂R, Q₂Q₃R and Q₃Q₁R in P_{A}, in an alternative embodiment, triangle Q₁Q₂Q₃ is instead replaced by triangle Q₁Q₂R and polygon Q₁RQ₂Q₃ as will be described in greater detail below. In another embodiment of the present disclosure, step 5 may be removed, when the point R is not connected to any vertices. It is to be appreciated that in some 3D model formats, the step of replacing 5 may be similar to adding any connections between the new points and any vertices.

It is to be appreciated that parameters T and T′ control the accuracy while parameters t and t′ control the “quality” (i.e., the balance of the new faces). Parameters T and T′ should be taken as large as possible so as there is no error in the decoding process. When input vertices are encoded as single-precision floating-point numbers, numerical experiments show that the choice T=T′=19 is optimal. Parameters t and t′ must satisfy the conditions 1≤t<T and 0≤t′<T′. A smaller value for t (resp. t′) increases the chance that the resulting point is close to the barycenter. Furthermore, it is preferable to balance the values oft and t′ by choosing t′=t or t′=t−1. It is to be appreciated that the value of t+t′ indicates the number of bits that can be encoded in an extra point.

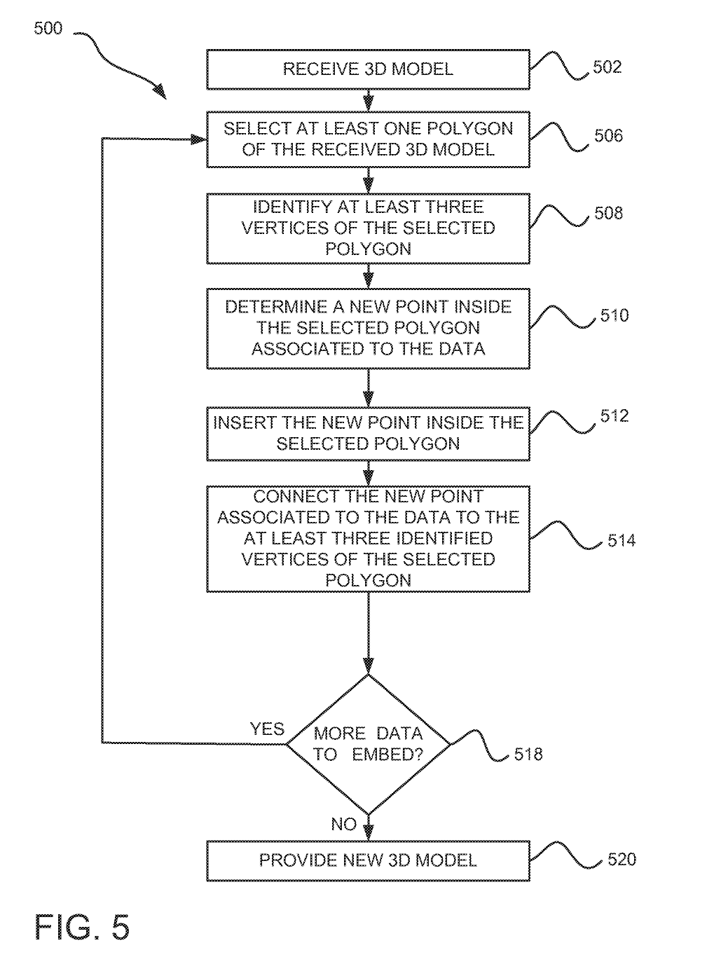

Turning to FIG. 5, an exemplary process 500 for embedding data in a 3D model is shown in accordance with the present disclosure. It is to be appreciated that process 500 can be used with system 400A and the algorithm described above to embed data in a 3D model, such as 3D model 200.

Initially, process 500 receives a 3D model, such as 3D model 200 (e.g., by engine 404A), in step 502. Then, the normalized barycentric coordinates (i.e., λ₀ and λ₃) may be determined (e.g., by barycentric coordinate module 410) based on the data Ω, as described above. For example, the barycentric coordinates may be calculated as follows:

$${λ}_{3} = \frac{1}{3} + {\sum }_{i = 0}^{t - 1} {b}_{k + i} {2}^{i - T}$$

And, letting k′=k+t:

$${λ}_{0} = \frac{1}{2} + {\sum }_{i = 0}^{{t}^{′} - 1} {b}_{{k}^{′} + i} {2}^{i - {T}^{′}}$$

It is to be appreciated that in some embodiments, the data Ω is stored (e.g., in data storage 412 in 3D engine 404A). In another embodiment, the barycentric coordinates may have been pre-calculated and stored. Then, in one embodiment, process 500 identifies the 3D format of the received 3D model (e.g., by 3D format identifier 206). For example, the 3D format of the received 3D model (i.e., 3D model 200) may be the OFF format described above. In one embodiment, identifying the 3D format is not necessary, since the 3D format is already known. Once the 3D format of the received model has been identified or determined, or if the 3D format is already known, process 500 selects at least one polygon (e.g., triangle) of the received 3D model, in step 506 (e.g., by polygon extraction module 408). It is to be appreciated that any polygon of the received 3D model may be selected in step 506. After the polygon is selected (e.g., triangle 202 of 3D model 200), process 500 identifies at least three vertices of the selected polygon (e.g., points 302, 306, and 308 in similar triangle 300 of FIG. 3), in step 508 (e.g., by polygon extraction module 408).

Next, process 500 determines a new or extra point (e.g., point 310 in triangle 300) associated to the data (e.g., by data association module 414), in step 510. The data may be stored or received (e.g., in data storage 412). The association may be based on the identified vertices of the selected polygon (e.g., points 302, 306, and 308) and the determined or pre-computed normalized barycentric coordinates (e.g., λ₀ and λ₃). Then, process 500 inserts the new point (e.g., point 310) inside the identified polygon (e.g., triangle 202), in step 512 (e.g., by 3D model provider 418). Next, process 500 connects the new point (e.g., point 310) to the identified vertices of the selected polygon (e.g., points 302, 306, 308), in step 514. Step 514 forms new polygons that are contained inside the selected polygon and are smaller than the selected polygon. For example, in triangle 300, step 514 of process 500 forms a first new triangle (e.g., triangle 320), a second new triangle (e.g., triangle 322) and a third new triangle (e.g., triangle 324). Then, in one embodiment, process 500 may update the 3D model representation (e.g., a file in the OFF format). The updating may include replacing the selected polygon with smaller polygons resulting from the connecting step 514. For example, after the first, second, and third new triangles are formed in triangle 300, process 500 may update the 3D model representation by replacing the identified triangle (e.g., triangle 202, 300) in the received 3D model (e.g., 3D model 200) with the first, second, and third new triangles (e.g., triangles 320, 322, and 324). It is to be appreciated that in some 3D model formats, the step of updating may be similar to adding any connections between the new points and any vertices, as already performed in step 514.

It is to be appreciated that, in an alternative embodiment, after process 500 inserts the new point (e.g., point 310) inside the selected polygon (e.g., triangle 202) in step 512, the steps of connecting 514 and updating are not present, since the new point is not connected to any vertex of the polygon. It is also to be appreciated that in another alternative embodiment, after process 500 inserts the new point (e.g., point 310) inside the identified polygon (e.g., triangle 202), in step 512, process 500 will only connect the new point (e.g., point 310) to two of the three vertices of the identified polygon (e.g., in one embodiment, only points 302 and 308), in step 514. For example, referring to FIG. 3, if process 500 connects new point 310 to points 302 and 308, new triangle 324 is formed, where new triangle 324 is formed by lines 316, 318, and the lines connecting point 302 to point 308 (i.e., Q₁Q₂R). Furthermore, by connecting new point 310 to points 302 and 308, a four-sided polygon is formed, where the new four sided polygon is formed by lines 316, 318, and the lines connecting point 302 to point 306 and point 306 to 308 (i.e., Q₁RQ₂ Q₃). After the new triangle and the new four-sided polygon are formed, process 500 may replace the identified triangle (e.g., triangle 202, or similar 300) in the received 3D model (e.g., 3D model 200) with the new triangle (e.g., triangle 324 in triangle 300) and the new four-sided polygon (e.g., Q_{1R}RQ₂ Q₃ described above), in the step of updating. It is to be appreciated that in some 3D model formats, the step of updating may be similar to adding any connections between the new points and any corresponding vertices, as already performed in step 514.

It is to be appreciated that more than one new point may be added to a received 3D model (such as 3D model 200) as is necessary to encode all the data associated with string Ω. For example, after the new point has been added to the 3D model, process 500 performs a check (e.g., of data storage 412 and data association module 414) to determine if all the desired data was associated to the new point (e.g., 210 in triangle 250, 310 in triangle 300), in step 518. As seen in the algorithm above, k is initialized from 0 and used to keep track of the number of bits (t+t′) that have been added (i.e., associated to a new point) to the 3D model. Therefore, in step 518 (and as seen in the algorithm above) k is updated to k+t+t′ to reflect the current number of bits that have been added to the 3D model. If process 500 determines in step 518 that there is still data left to be encoded (i.e., k<l) in the received 3D model (e.g., 3D model 200), then the process returns to step 506. For example, barycentric coordinate module 410 will determine new barycentric coordinates associated with the remaining data and new triangle (e.g., a triangle on model 200 other than triangle 202) will be selected from the received 3D model, in step 506, and the remaining data will be associated to the new point and embedded in the received 3D model via steps 508 to 514, as described above. In this way, steps 506 to 518 will be iteratively repeated until enough points have been added to the received 3D model, such that all the data in data string Ω has been encoded to the 3D model. When process 500 determines that all the data in data string Ω has been encoded to the 3D model, in step 518, then process 500 provides a new 3D model (e.g., 3D model 250) including any new points and connections that may have been added to the received 3D model, in step 520 (e.g., by 3D model provider 418). It is to be appreciated that the new 3D model (e.g., 3D model 250) provided in step 520 can be in the same or a different 3D format as the received 3D model (e.g., 3D model 200).

It is to be appreciated that in one embodiment, process 500 adds multiple new points to the same selected polygon (e.g., by engine 404A). For example, when process 500 receives 3D model 200, two sets of barycentric coordinates may be determined (e.g., by barycentric coordinate module 410), where a first barycentric coordinate set is λ₀₁ and λ₃₁ and the second barycentric coordinate set is λ₀₂ and λ₃₂. Furthermore, the first barycentric coordinate set is determined based on a first portion of the data string (using the method described above) and the second barycentric coordinate set is determined based on the second portion of the data string (based on the method described above). In this way, process 500, in step 510, can determine a first new point based on the first set of barycentric coordinates, where the first new point is associated to the first portion of the data string, and a second new point based on the second set of barycentric coordinates, where the second new point is associated to the second portion of the data string (e.g., by data association module 414). The first and second new point can both be inserted into a selected polygon of the received 3D model (i.e., triangle 202 of 3D model 200), in step 512. It is to be appreciated that although in the above described example it is stated that process 500 can add two new points to a selected polygon (such as triangle 202), more points can be inserted into a selected polygon as desired. Furthermore, in another embodiment, process 500 can add multiple points to multiple selected polygons of a received 3D model. For example, a first and a second new point, as described above, can be inserted into a first selected polygon, and a third and fourth new point can be inserted into a second selected polygon. It is to be appreciated that the various embodiments of process 500 also apply to process 100.

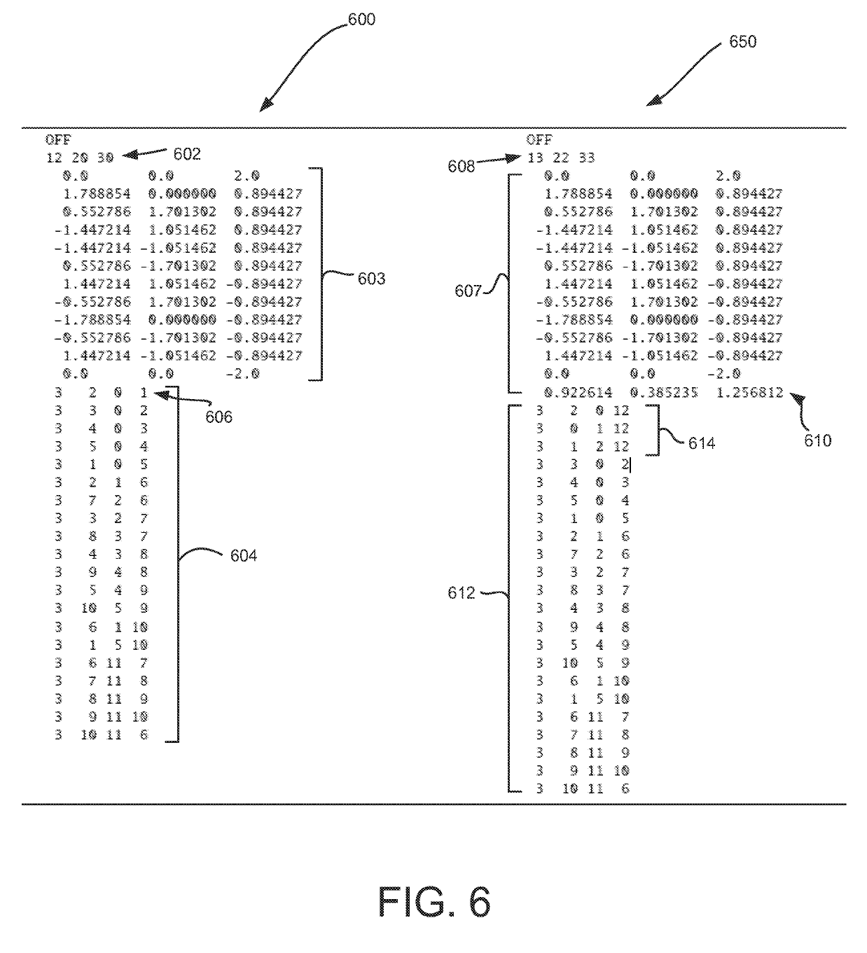

Turning to FIG. 6, an exemplary illustration of the model 200 in the OFF format (as described above) without the extra data embedded (on the left side) and the model 250 in the OFF format after the extra data has been embedded (on the right side, i.e., model 200 shown in FIG. 2B with added point 210) is shown in accordance with the present disclosure. It is to be appreciated that, in FIG. 6, 3D model 200, as shown in FIG. 2A, is indicated by reference number 600, and 3D model 250, as shown in FIG. 2B with the new data embedded, is indicated by reference number 650.

Original 3D model representation in the OFF format 600 includes a first line 602 that includes the number of vertices, faces (or polygons), and edges of the icosahedron model shown in FIG. 2A, where, as seen in FIG. 6, line 602 includes 12 vertices, 20 faces, and 30 edges. Original 3D model 600 also includes a section 603, where section 603 includes a list of all the vertices in original 3D model 600. Each of the vertices in section 603 is listed with x, y, z, coordinates and each of the vertices comprises one line in section 603. Original 3D model 600 also includes section 604, where section 604 includes all of the faces of original 3D model 600 as vectors containing the number of vertices followed by the sequence number of the composing vertices (indexed from 0 to 11 for a total of 12 vertices in the original 3D model 600). Each of the faces in section 604 comprises one line in section 604. Line 606 in section 604 of original 3D model 600 represents the face of original 3D model 600 that has been chosen to receive the extra point associated with the extra data (i.e., point 310).

The 3D model representation in the OFF format 650 (i.e., model 200 with the embedded data associated to point 210, similar to point 310 in FIG. 3) includes a first line 608 that includes the number of vertices, faces, and edges of the icosahedron model shown in FIG. 2B, where, as seen in FIG. 6, line 608 includes 13 vertices, 20 faces, and 30 edges. It is to be appreciated that line 608 shows one additional vertex than line 602 (13 vs. 12) because a new point has been added to the model (i.e., extra point 210). 3D model 650 also includes a section 607, where section 607 includes a list of all the vertices in original 3D model 600 in addition to the new point 610. It is to be appreciated that point 610 in FIG. 6, is the same as point 210 in FIG. 2B. Each of the vertices in section 607 is listed with x, y, z, coordinates and each of the vertices comprises one line in section 607. The 3D model 650 also includes section 612, where section 612 includes all of the faces of original 3D model 600, however, line 606 (i.e., the face chosen so that a new point is added), has been replaced with 3 new faces as shown in section 614. It is to be appreciated that the 3 new faces shown in section 614 are formed when the new point 610 (i.e., new point 210 from FIG. 2B, or 310 in FIG. 3) has been added to the 3D model (as shown in FIGS. 2B and 3) and the new point 610 (i.e., new point 210 or 310) is connected to the vertices of the triangle/face (i.e., triangle 202 or 300) the new point 610 has been added to.

Referring to FIGS. 3 and 6 it can be seen that the new point 310 has been connected to the vertices 302, 306, and 308, where the line 316 connects to new point 310 and point 302, line 314 connects to new point 310 and point 306, and line 318 connects to new point 310 and point 308 (i.e., step 514 in process 500). It is to be appreciated that the lines 314, 316, and the line connecting points 302 to 306 form a new face or triangle 320, where face or triangle 320 is the same as the face listed in the first line of section 614. The lines 314, 318, and the line connecting points 306 to 308 form a new face or triangle 322, where face or triangle 322 is the same as the face listed in the second line of section 614. The lines 316, 318, and the line connecting points 302 to 308 form a new face or triangle 324, where face or triangle 324 is the same as the face listed in the third line of section 614.

It is to be appreciated that the extra data embedded in 3D model 650 may be any type of data that is represented in binary. For example, in the extra data embedded in 3D model 650 (i.e., 3D model 250 shown in FIG. 2B) is π to 10 decimal digits (i.e., 3.141592653). Parameters were set to T=T′=19 and t=t′=16. It is to be appreciated the position of the added point 610 is shown in FIG. 6 as 0.922614, 0.385235, 1.256812, as x, y, and z coordinates, and the new point 610 (i.e., point 310) encodes the first digits of π.

Once new data has been embedded in a 3D model, such as 3D model 250, the new data can later be decoded and extracted to retrieve the data stored in the new model. For example, referring to FIG. 4B, engine 404B of system 400B includes extra point detector 416 and data extractor 420. When a 3D model 450 with embedded data (such as 3D model 250) is received by engine 404B, extra point detector 416 is configured to detect any points (such as point 210) that have been added to a 3D model and associated to data. Furthermore, data extractor 420 is configured to extract or decode the data associated with the extra points detected by extra point detector 416. The decoded data 460 can then be outputted by engine 404B to a user.

It is to be appreciated that, in one embodiment, when data is associated to new point 210/610 in 3D model 200/600 to provide 3D model 250/650 using engine 404A and process 500, engine 404A may be configured to add the new point 210/610 to the end of section 607 and the 3 new faces or triangles formed in step 514 (i.e., the 3 faces in section 614) to the top of section 612. Furthermore, if a second new point had been added to a second selected polygon of 3D model 200/600, the coordinates of the second new point can be added to the end (i.e., the last line) of section 607 and the three new faces formed by connected the new point to 3 vertices of the second selected polygon can be added directly after the 3 faces of section 614. In this way, any new points added to 3D model 200/600 can be added in succession at the end of section 607 and any new faces formed when data is embedded in a 3D model, such as 3D model 210/610, using engine 404A and process 500, can be added in succession to the top of section 612. Also, it is to be appreciated that new point 210/610 added to 3D model 200/600 is indicated by the number 12 in each of the three lines in section 614. This is because, as stated above, all the vertices of the 3D model are indexed from 0, and therefore, the newest point is represented by the number 12 (where the original vertices of 3D model 200/600 are represented by numbers 0-11 in sections 604 and 612). It is further to be appreciated, that if a second new point was added to 3D model 200/600, the second new point would be numbered 13 in section 612.

In one embodiment, extra point detector 416 of engine 404B can be configured to check the top of section 612 for the points with the highest index value to determine which points in 3D model 250/650 have been added (i.e., were not originally in 3D model 200/600). For example, when 3D model 250/650 is received by engine 404B, extra point detector 416 can determine that at the top of section 612, point 12 has the highest value and therefore represents the added point. Then, extra point detector 416 will check the end of section 607 to find the coordinates of the new point 610. It is to be appreciated that this process can be repeated to find other new points in 3D model 250/650. Furthermore, in one embodiment, extra point detector 416 can be configured such that it can determine the order the new points were originally added because the new points will be listed in the order they were added at the end of section 607.

It is to be appreciated that, in another embodiment, when data is associated to new point 310/610 in 3D model 200/600 to provide 3D model 250/650 using engine 404A and process 500, engine 404A can be configured to append a trailing 0 to at least one of the coordinates (listed in section 607) of the new point 210/610 and any other new points added during process 500. For example, in the currently described embodiment, at least one of the x, y, or z coordinates of new point 610, in section 607 can include an extra 0 on the end (e.g., 0.9226140 instead of 0.922614). Furthermore, at least one of the x, y, or z coordinates of any other new points added to 3D model 210/610 would also include a trailing 0 at the end. In this way, engine 404A has left an indication (e.g., the trailing 0) in 3D model 250/650 that can be used to identify new points that have been added to a 3D model. It is to be appreciated that extra point detector 416 of engine 404B can be configured to check the coordinates of the points in section 607 for any extra trailing 0's to detect any points that have been added.

It is to be appreciated that in yet another embodiment, extra point detector 416 of engine 404B can be configured to check or search for triangles (or, in general, polygons or faces) that are smaller than others to identify the presence of extra points in the 3D model.

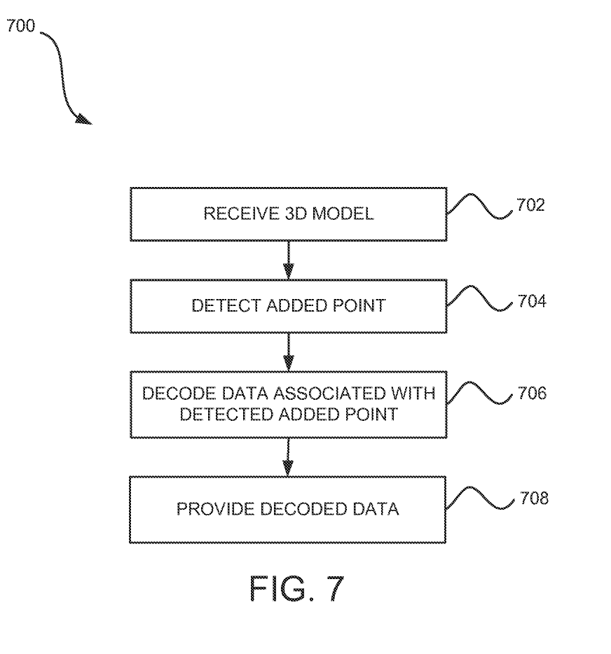

Turning to FIG. 7, an exemplary process 700 for decoding a 3D model that includes extra data (such as model 250 shown in FIG. 2B and model 650 shown in FIG. 6) is shown in accordance with the present disclosure. Initially, process 700 includes receiving a 3D model including extra data (in the form of one or more added points, such as new point 210/310/610 described above and shown in FIGS. 2B, 3, and 6), in step 702. Then, the process includes detecting any added points within the 3D model (such as point 310/610) (in a manner described above), in step 704 (e.g., by extra point detector 416 of engine 404B). Then, the process includes decoding any detected points (e.g., by data extractor 420) based on the location of the detected points, and the extra data associated with the added points is extracted or decoded, in step 706. It is to be appreciated that the decoding of step 706 will be described in greater detail below. Finally, in step 708, process 700 includes providing decoded data 460. It is to be understood that the step of providing 708 in the present disclosure includes outputting or storing the decoded data 460. It is to be understood that the functionalities and embodiments described for engine 404B also apply to process 700. In particular, the functionalities and embodiments described for extra point detector 416 and data extractor 420 also apply to steps 704 and 706 of process 700, respectively.

The data associated to a new point in a 3D model can be extracted as provided below.

According to the present disclosure, for extra points inserted according to a distance(s) from at least one vertex in one or two plane dimensions (or coordinates, or axes), the decoder computes the distance(s) and retrieves the data based on the distance(s). The function that identifies the data as a function of the distance may be a linear or non-linear function, or it may be a table of values of distance versus data.

According to the present disclosure, for extra points inserted according to barycentric coordinates, let Qᵢ=(xᵢ, yᵢ, zᵢ), for iϵ{1,2,3}, and R=(X, Y, Z) represent the coordinates of points Qᵢ and R. As described above R represents the point added to the 3D model (e.g., point 310 described above) and Q₁, Q₂, Q₃ represent the vertices of the triangle the new point was added to (e.g., points 302, 306, and 308). By construction, we have:

R=λ₁Q₁+λ₂Q₂+λ₃Q₃

or, using matrix notation,

$$( \begin{matrix}X \\ Y \\ Z\end{matrix} ) = {λ}_{1} ( \begin{matrix}{x}_{1} \\ {y}_{1} \\ {z}_{1}\end{matrix} ) + {λ}_{2} ( \begin{matrix}{x}_{2} \\ {y}_{2} \\ {z}_{2}\end{matrix} ) + {λ}_{3} ( \begin{matrix}{x}_{3} \\ {y}_{3} \\ {z}_{3}\end{matrix} ) = ( 1 - {λ}_{2} - {λ}_{3} ) ( \begin{matrix}{x}_{1} \\ {y}_{1} \\ {z}_{1}\end{matrix} ) + {λ}_{2} ( \begin{matrix}{x}_{2} \\ {y}_{2} \\ {z}_{2}\end{matrix} ) + {λ}_{3} ( \begin{matrix}{x}_{3} \\ {y}_{3} \\ {z}_{3}\end{matrix} ) ⇔ ( \begin{matrix}X - {x}_{1} \\ Y - {y}_{1} \\ Z - {z}_{1}\end{matrix} ) = {λ}_{2} ( \begin{matrix}{x}_{2} - {x}_{1} \\ {y}_{2} - {y}_{1} \\ {z}_{2} - {z}_{1}\end{matrix} ) + {λ}_{3} ( \begin{matrix}{x}_{3} - {x}_{1} \\ {y}_{3} - {y}_{1} \\ {z}_{3} - {z}_{1}\end{matrix} ) = ( \begin{matrix}{x}_{2} - {x}_{1} & {x}_{3} - {x}_{1} \\ {y}_{2} - {y}_{1} & {y}_{3} - {y}_{1} \\ {z}_{2} - {z}_{1} & {z}_{3} - {z}_{1}\end{matrix} ) ( \begin{matrix}{λ}_{2} \\ {λ}_{3}\end{matrix} )$$

We thus have:

$$( \begin{matrix}{λ}_{2} \\ {λ}_{3}\end{matrix} ) = {( {ℳ}^{T} ℳ )}^{- 1} {ℳ}^{T} \vec{V} where$$

$$ℳ = ( \begin{matrix}{x}_{2} - {x}_{1} & {x}_{3} - {x}_{1} \\ {y}_{2} - {y}_{1} & {y}_{3} - {y}_{1} \\ {z}_{2} - {z}_{1} & {z}_{3} - {z}_{1}\end{matrix} ) and \vec{V} = ( \begin{matrix}X - {x}_{1} \\ Y - {y}_{1} \\ Z - {z}_{1}\end{matrix} )$$

which yields the value of

$${λ}_{0} = \frac{{λ}_{2}}{1 - {λ}_{3}}$$

and of λ₃. We then drive:

$${b}_{k + t - 1} … {b}_{k} = {\sum }_{i = 0}^{t - 1} {b}_{k + i} {2}^{i} = ⌊ {2}^{T} ( {λ}_{3} - \frac{1}{3} ) ⌉ and$$

$${b}_{{k}^{′} + {t}^{′} - 1} … {b}_{{k}^{′}} = {\sum }_{i = 0}^{{t}^{′} - 1} {b}_{{k}^{′} + i} {2}^{i} = ⌊ {2}^{{T}^{′}} ( {λ}_{0} - \frac{1}{2} ) ⌉$$

where └⋅┐ denotes the rounding function.

As seen above, by determining the barycentric coordinates λ₀ and λ₃, the binary representation of the embedded data can be determined. It is to be understood the detection assumes knowledge of the parameters: T and T′, which should be provided to the decoder, or known in advance.

Since points Qᵢ are distinct, matrix M has rank 2. Another way to get (λ₂, λ₃) is to select two linearly independent rows of M and the corresponding rows in \vec{V}. For example, if the first rows of M are linearly independent, we derive:

$$( \begin{matrix}{λ}_{2} \\ {λ}_{3}\end{matrix} ) = {( \begin{matrix}{x}_{2} - {x}_{1} & {x}_{3} - {x}_{1} \\ {y}_{2} - {y}_{1} & {y}_{3} - {y}_{1}\end{matrix} )}^{- 1} ( \begin{matrix}X - {x}_{1} \\ Y - {y}_{1}\end{matrix} )$$

yielding λ₀ and λ₃, or more explicitly:

$${λ}_{0} = \frac{( X - {x}_{1} ) ( {y}_{3} - {y}_{1} ) - ( Y - {y}_{1} ) ( {x}_{3} - {x}_{1} )}{( {x}_{2} - {x}_{1} ) ( {y}_{3} - Y ) - ( {y}_{2} - {y}_{1} ) ( {x}_{3} - X )} and$$

$${λ}_{3} = \frac{( X - {x}_{1} ) ( {y}_{2} - {y}_{1} ) - ( Y - {y}_{1} ) ( {x}_{2} - {x}_{1} )}{( {x}_{3} - {x}_{1} ) ( {y}_{2} - {y}_{1} ) - ( {y}_{3} - {y}_{1} ) ( {x}_{2} - {x}_{1} )}$$

It is to be appreciated that system 400A and process 100 and 500 described above can also be extended to r-sided polygons with r≥4. In other words, in another embodiment of the present disclosure, system 400A and process 100 and 500 can be used to embed data in a 3D model where the surface of the 3D model is mapped with polygons that have more than 3 sides. Barycentric coordinates can be defined for r≥4 as will be described below.

In one embodiment, the barycentric coordinates are defined for r≥4 by triangulating an r-sided polygon into r−2 triangles and then applying process 500 on each triangle. For example, applied to a quad (i.e., a planar polygon with r=4 sides) this would result in 2×3=6 new triangles.

Below an implementation of process 500 for a 3D model where the surface of the 3D model is mapped using a plurality of quads is described. However, it is to be appreciated that process 500 can be implemented for polygons with more than 4 sides.

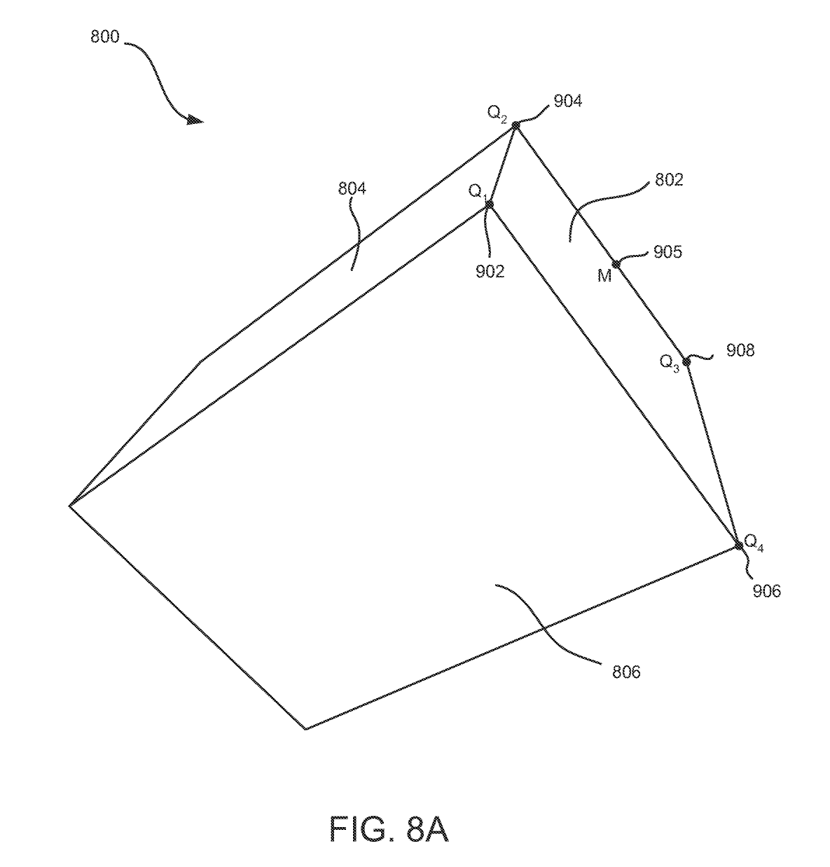

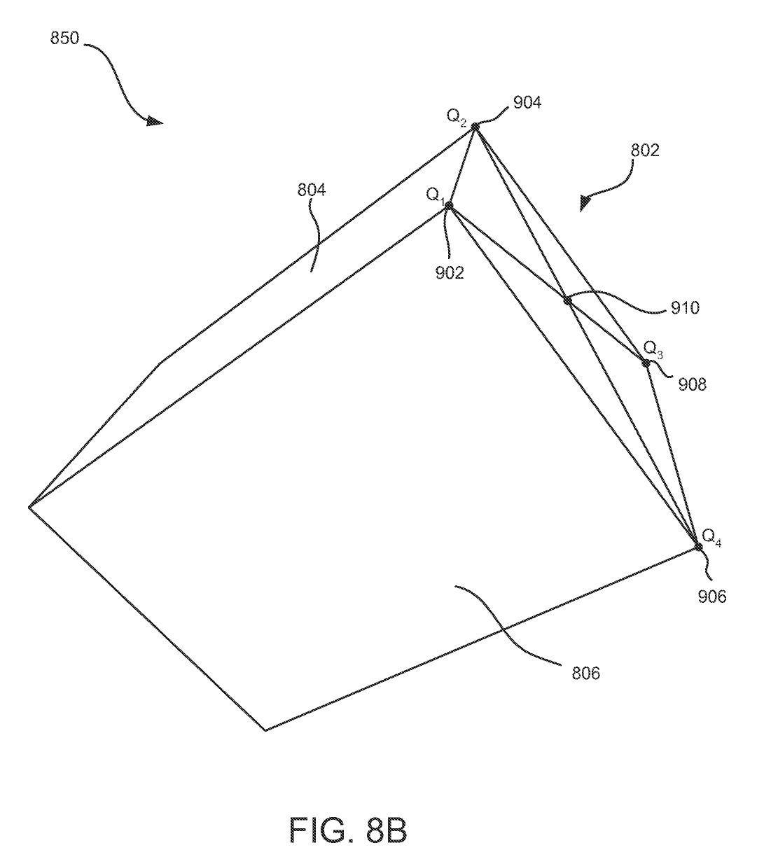

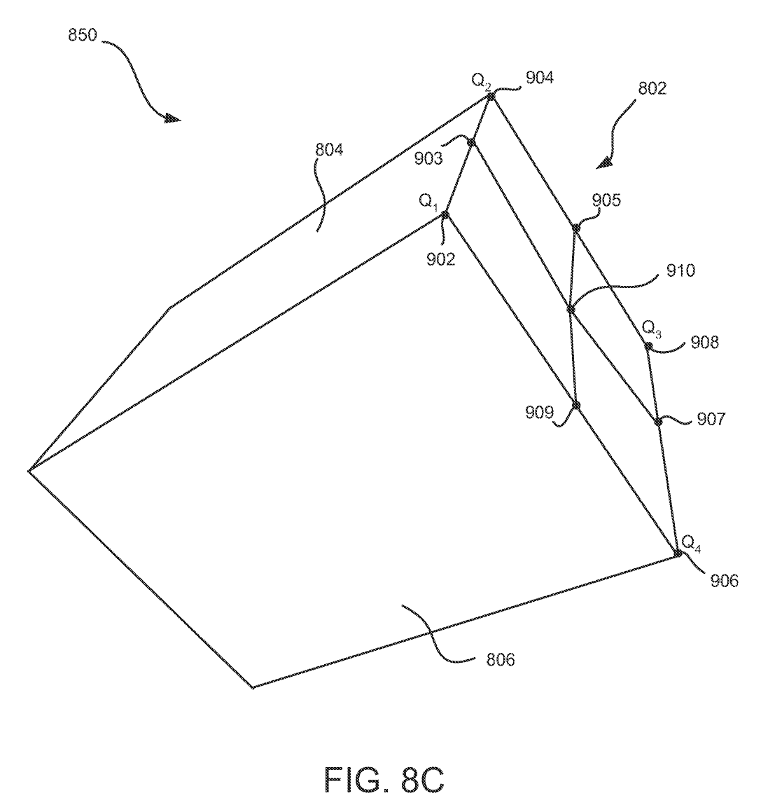

Turning to FIG. 8A, a 3D model 800 is shown, where 3D model 800 is a 3D model of a cube. As seen in FIG. 8A, the surface of FIG. 800 is mapped using a plurality of quads or quadrangles. The quad faces visible in FIG. 8A are quads 802, 804, and 806. In one embodiment, engine 404A or process 500 is used to embed data in 3D model 800. For example, engine 404A and process 500 may be used to insert a point associated to data in quad 802 of 3D model 800, where quad 802 is formed by vertices 902, 904, 906, and 908. As described above, to associate data (stored in data storage 412) to a 3D model, barycentric coordinate module 410 is configured to calculate barycentric coordinate λ₃ and λ₀ based on the string of data desired to be embedded in the 3D model. For a polygon with 4 sides, such as quad 802, barycentric coordinates λ₃ and λ₀ are calculated by barycentric coordinate module 410 as follows:

$${λ}_{3} = \frac{1}{2} + {\sum }_{i = 0}^{t - 1} {b}_{k + i} {2}^{i - T} and {λ}_{0} = \frac{1}{2} + {\sum }_{i = 0}^{{t}^{′} - 1} {b}_{{k}^{′} + i} {2}^{i - {T}^{′}}$$

Furthermore, the new point (R in the equation below) to be added to quad 802 will be determined (i.e., step 510) as follows:

R=(1−λ₃)R₀+λ₃M where R₀=(1−+λ₀)Q₁+λ₀Q₂

It is to be appreciated that Q₁ is the same as vertex 902 and Q₂ is the same as vertex 904 of quad 802. Furthermore, it is to be appreciated that M is defined as M=½Q₂+½Q₃, where Q₃ is the same as vertex 908 in quad 802, and where is the middle point 905 of the line connecting vertex 904 and 908 in FIG. 8A. It is to be appreciated that the first term of λ₃ may be ½ (as opposed to ⅓ as described above in previous embodiments). By setting the first term of λ₃ to ½ a more central position can be achieved for the resulting new point R.

Turning to FIG. 8B, 3D model 850 is shown in accordance with an embodiment of the present disclosure, where 3D model 850 is 3D model 800 after new point 910 (i.e., R as calculated above) has been associated to the desired data and added to quad 802 using engine 404A or process 500. It is to be appreciated that although only one point (i.e., point 910) has been added to 3D model 800, as stated above, more points may be added (for example to quads 804 and 806) to embed more data in 3D model 800 as desired. In the embodiment shown in FIG. 8B, extra point 910 has been connected to 4 vertices of quad 802, vertices 902, 904, 906, and 908, to form 4 new triangles. It is to be appreciated that, in one embodiment, after engine 404A or process 500 has associated the data to the new point 910, 3D model provider 418 or step 520 will provide 3D model 850 (as seen in FIG. 8B). Process 500 or 3D model provider 418 may also previously update the 3D model representation by replacing quad 802 with the 4 new triangles created by connecting 514 extra point 910 to vertices 902, 904, 906, and 908.

In an alternative embodiment shown in FIG. 8C, extra point 910 has been connected to the mid-point of the lines formed by points 902, 904, 906, 908. Specifically, extra point 910 has been connected to point 903, where point 903 is disposed on the line formed by points 902 and 904, extra point 910 has been connected to point 905, where point 905 is disposed on the line formed by points 904 and 908, extra point 910 has been connected to point 907, where point 907 is disposed on the line formed by points 906 and 908, extra point 910 has been connected to point 909, where point 909 is disposed on the line formed by points 902 and 906. As seen in FIG. 8B, when extra point 910 is connected to points 903, 905, 907, and 909, 4 new squares are formed. It is to be appreciated that, in one embodiment, after engine 404A or process 500 has associated the data to the new point 910, 3D model provider 418 or step 520 will provide 3D model 850 (as seen in FIG. 8C). Process 500 or 3D model provider 418 may also previously update the 3D model representation by replacing quad 802 with the 4 new squares created by connecting 514 extra point 910 to points 903, 905, 907, 909.

It is to be appreciated that extra point 910 shown in FIGS. 8B and C encodes the first 10 digits of π, similar to the example described above. Using the above described method, we obtain R=(−0.147885, −0.077018,1.0) (where R is extra point 910), with parameters T=T′=19 and t=t′=16.

It is to be appreciated that the data embedded in a 3D model (as described above using system 400A and process 100 and 500) may be implemented for many applications. For example, in some embodiments of the present disclosure, the embedded data is used for information hiding, or more exactly, embedding of private information. In this embodiment, Ω represents the encryption of some plaintext message. The knowledge of Ω only reveals a ciphertext and the corresponding decryption key is needed to recover the message in the clear. In another embodiment, the embedded data is used for authentication. In this case, Ω represents the digital of some plaintext message. A useful sub-case is when the plaintext message is the representation of the initial 3D object. Ω may then be used to check the authenticity of the 3D object.

Furthermore, it is to be understood that the present disclosure can be applied to watermarking systems in many scenarios. For example, in one embodiment, the data embedded in the 3D model (as described above) may be the watermark payload. The new or extra points are the watermarks, representing the coded information of the data payload. In one embodiment, the data may be the owner and/or the original creator of the 3D model.

In addition, the present disclosure may be implemented in various forms of hardware, software, firmware, special purpose processors, or a combination thereof. The methods or processes of the present disclosure are implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

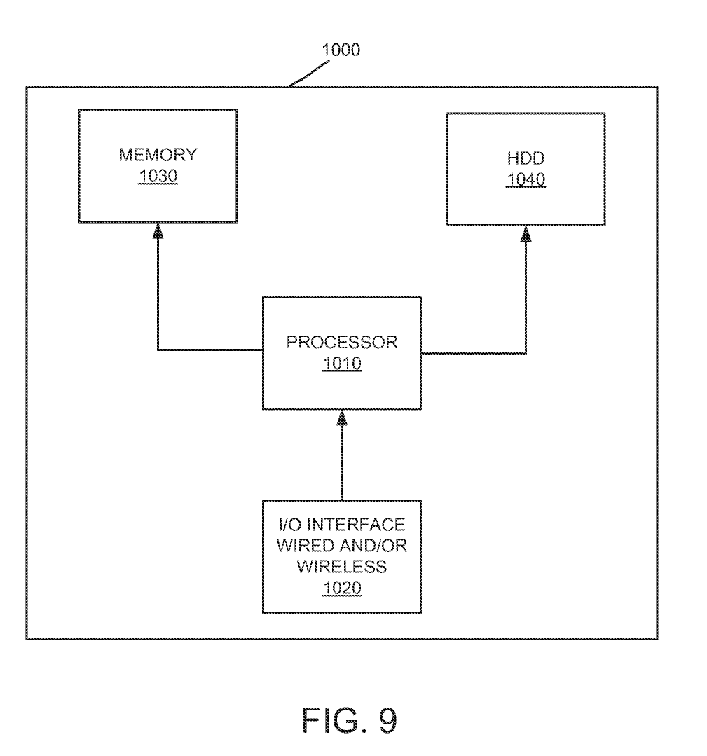

FIG. 9 shows a block diagram of an exemplary computing environment 1000 within which any of the methods of the present disclosure can be implemented and executed. The computing environment 1000 includes a processor 1010, and at least one I/O interface 1020. The I/O interface 1020 can be wired or wireless and, in the wireless implementation is pre-configured with the appropriate wireless communication protocols to allow the computing environment 1000 to operate on a global network (e.g., internet) and communicate with other computers or servers (e.g., cloud based computing or storage servers) so as to enable the present disclosure to be provided, for example, as a Software as a Service (SAAS) feature remotely provided to end users. One or more memories 1030 and/or storage devices (Hard Disk Drives, HDD) 1040 are also provided within the computing environment 1000. The computing environment may be used to implement a node or device, and/or a controller or server who operates the storage system. The computing environment may be, but is not limited to, desktop computers, cellular phones, smart phones, phone watches, tablet computers, personal digital assistant (PDA), netbooks, laptop computers, set-top boxes or general multimedia content receiver and/or transmitter devices.

Furthermore, aspects of the present disclosure can take the form of a computer-readable storage medium. Any combination of one or more computer-readable storage medium(s) may be utilized. A computer-readable storage medium can take the form of a computer-readable program product embodied in one or more computer-readable medium(s) and having computer-readable program code embodied thereon that is executable by a computer. A computer-readable storage medium as used herein is considered a non-transitory storage medium given the inherent capability to store the information therein as well as the inherent capability to provide retrieval of the information therefrom. A computer-readable storage medium may be, for example, but is not limited to, an electronic, magnetic, optical, electromagnetic, infrared, or semiconductor system, apparatus, or device, or any suitable combination of the foregoing.

It is to be appreciated that the following list, while providing more specific examples of computer-readable storage mediums to which the present disclosure may be applied, is merely an illustrative and not exhaustive listing as is readily appreciated by one of ordinary skill in the art. The list of examples includes a portable computer diskette, a hard disk, a read-only memory (ROM), an erasable programmable read-only memory (EPROM or Flash memory), a portable compact disc read-only memory (CD-ROM), an optical storage device, a magnetic storage device, or any suitable combination of the foregoing.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations that fall within the scope of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope of the present disclosure. All such changes and modifications are intended to be included within the scope of the present disclosure as set forth in the appended claims.

1. A method of embedding data in a three-dimensional (3D) model, the method comprising:
receiving a first 3D model comprising a plurality of polygons;
selecting at least one polygon of the plurality of polygons;
inserting at least one new point associated to data inside the selected at least one polygon to obtain a second 3D model; and
providing said second 3D model.

2-14. (canceled)

15. An apparatus for embedding data in a three-dimensional (3D) model, the apparatus comprising:
a processor in communication with at least one input/output interface; and at least one memory in communication with the processor, the processor being configured to:
receive a first 3D model comprising a plurality of polygons;
select at least one polygon of the plurality of polygons;
insert at least one new point associated to data inside the selected at least one polygon to obtain a second 3D model; and
provide said second 3D model.

16-28. (canceled)

29. A method of decoding data embedded in a three-dimensional (3D) model, the method comprising:
receiving a 3D model comprising a plurality of polygons;
detecting at least one added point inserted in a polygon of the plurality of polygons;
decoding data associated to the detected at least one added point based on the location of the detected at least one added point inserted in the polygon; and
providing said decoded data.

30. The method of claim 29, further comprising:
identifying at least one vertex of the polygon; and
decoding data associated to the detected at least one added point also based on the at least one vertex of the polygon.

31. The method of claim 29, further comprising:
identifying at least three vertices of the polygon; and decoding data associated to the detected at least one added point also based on the at least three vertices of the polygon.

32. The method of claim 29, further comprising: determining at least a first and a second barycentric coordinate, wherein the first and second barycentric coordinates are associated to the data.

33. The method of claim 32, wherein the decoding further includes:
decoding based on the first and second barycentric coordinates.

34. The method of claim 29, wherein the detecting further includes:
identifying at least one polygon that is smaller than at least another polygon.

35. The method of claim 29, wherein the polygon is a triangle.

36. The method of claim 29, wherein the polygon is a quadrangle.

37. The method of claim 29, wherein the detecting further includes:
detecting an indication that indicates the detected at least one added point is not an original vertex of the 3D model.

38. An apparatus for decoding data embedded in a three-dimensional (3D) model, the apparatus comprising:
a processor in communication with at least one input/output interface; and at least one memory in communication with the processor, the processor being configured to:
receive a 3D model comprising a plurality of polygons;
detect at least one added point inserted in a polygon of the plurality of polygons and identify at least three vertices of the polygon;
decode data associated to the detected at least one added point based on the location of the detected at least one added point inserted in the polygon; and provide said decoded data.

39. The apparatus of claim 38, wherein the processor is further configured to:
identify at least one vertex of the polygon; and
decode data associated to the detected at least one added point also based on the at least one vertex of the polygon.

40. The apparatus of claim 38, wherein the processor is further configured identify at least three vertices of the polygon; and decode data associated to the detected at least one added point also based on the at least three vertices of the polygon.

41. The apparatus of claim 38, wherein the processor is further configured to:
determine at least a first and a second barycentric coordinate, wherein the first and second barycentric coordinates are associated to the data.

42. The apparatus of claim 41, wherein the processor is further configured to:
decode based on the first and second barycentric coordinates.

43. The apparatus of claim 38, wherein the processor is further configured to:
identify at least one polygon that is smaller than at least another polygon.

44. The apparatus of claim 38, wherein the polygon is a triangle.

45. The apparatus of claim 38, wherein the polygon is a quadrangle.

46. The apparatus of claim 38, wherein the processor is further configured to: detect an indication that indicates the detected at least one added point is not an original vertex of the 3D model.
